(19) United States
(12) Patent Application Publication
(10) Pub. No.: US 2012/0262532 A1
(43) Pub. Date: Oct. 18, 2012

(54) SYSTEMS AND METHODS FOR PROVIDING VIDEO CONFERENCING GLOBALY

(76) Inventor: TAI CHEUNG POON, Hong Kong (HK)

(21) Appl. No.: 13/088,368

(22) Filed: Apr. 17, 2011

(51) Int. Cl. H04N 7/14

(52) U.S. Cl. 348/14.02; 348/E07.081

(57) ABSTRACT

The invention refers to a video conference system for determining time information identified in documents presented as video images during video conferences. In one embodiment, the invention uses a communication server and two mobile devices. The communication server supports video conferences between two users and receives video images from one mobile device user and sends the video images to another mobile device user. The first mobile device represents a remote device, and location capabilities of the first mobile device include GPS technology only. The first mobile device includes a first GPS receiver. The first mobile device is being based in a first geographic area of a first time zone; and during the video conferences, documents are allowed to be sent by a first user of the first mobile device to other users as video images. A second mobile device representing a local device, wherein location capabilities of the second mobile device include GPS technology only; the second mobile device is being based in a second geographic area of a second time zone; the second mobile device includes a second GPS receiver; and a second user of the second mobile device conducts a video conference with the first user of the first mobile device through the communication server.

### FIELD OF THE INVENTION

The invention is generally related to methods and systems for providing video conferences globally. Specifically, and without limitation, this invention relates to determining time information identified in documents presented as video images during video conferences.

### BACKGROUND OF THE INVENTION

Video conference is increasingly popular in the commercial world. When oil price increases, business travel budget will continue to be tight in the foreseeable years. When that happens, companies are looking ways to save costs. To be efficient, one way is to hold online meetings. Traditionally, video conference is usually held between computers. With the arrival of smart phones, video conferences through intelligent smart phones will dominant the video conference in years to come, especially in international business. The problem is, many participants come from various countries in the world. Current systems in video conferences are not able to adequately handle the requirements by international clients, especially if meetings are held in different places with various time requirements. This invention is intended to solve the above problems.

### SUMMARY OF THE INVENTION

Systems and methods are provided for determining time information identified in documents presented as video images during video conferences. According to one embodiment of the invention, a system is included. The system comprises a communication server connecting a first mobile device and a second mobile device; a first mobile device representing a remote device; and a second mobile device representing a local device.

In the embodiment, location capabilities of the second mobile device include GPS technology only. The second mobile device is being based in a second geographic area of a second time zone. The second mobile device includes a second GPS receiver; and a second user of the second mobile device conducts a video conference with the first user of the first mobile device through the communication server, where during the video conference, the first user of the first mobile device has initiated to show certain content information of a document to the second user of the second mobile device through the communication server by video images, wherein the content information includes time information.

Further in the embodiment, the time information fails to include any time zone related information; and comes with a format providing hours and minutes information only; and after the communication server has received the initiation by the first mobile device to show the content information to the second user, the communication server processes the video images to determine if any time information included in the content information is found, where if the video images are found to include the time information, the communication server performs time adjustment, including receiving the first geographic area of the first mobile device after prompting the first mobile device's GPS receiver for location information; receiving the second geographic area of the second mobile device after prompting the second mobile device's GPS receiver for location information; based on the received first and second geographic areas, determining the first time zone and the second time zone respectively; computing time zone difference between the first and second geographic areas; and converting the time information in view of the computed time zone difference.

Further in the embodiment, the communication server modifies the received video images by replacing the time information with the converted time information in view of the time zone difference between the first and second geographic areas; the communication server sends the modified video images to the second mobile device for display; and the second mobile device displays the modified video images to the second mobile user, including the converted time information in view of the time zone difference; and if the video images fail to include the time format, the communication server sends the video images to the second mobile device unmodified.

### BRIEF DESCRIPTION OF THE DRAWINGS

FIG. 1 illustrates an exemplary system for handling video conferencing globally.

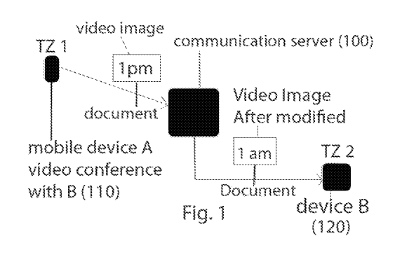

### DETAILED DESCRIPTION

Systems and methods are provided for determining time information identified in documents presented as video images during video conferences. Embodiments of the inventions may include a video conference system. The system includes a communication server (100) connecting the first mobile device (110) and the second mobile device (120); wherein the communication server (100) supports video conferences between two users; and the communication server (100) receives video images from one mobile device user and sends the video images to another mobile device user; a first mobile device (110) representing a remote device, wherein location capabilities of the first mobile device (110) include GPS technology only; the first mobile device (110) includes a first GPS receiver; the first mobile device (110) is being based in a first geographic area of a first time zone; and during the video conferences, documents are allowed to be sent by a first user of the first mobile device (110) to other users as video images; and a second mobile device (120) representing a local device, wherein location capabilities of the second mobile device (120) include GPS technology only; the second mobile device (120) is being based in a second geographic area of a second time zone; the second mobile device (120) includes a second GPS receiver; and a second user of the second mobile device (120) conducts a video conference with the first user of the first mobile device (110) through the communication server (100), where during the video conference, the first user of the first mobile device (110) has initiated to show certain content information of a document to the second user of the second mobile device (120) through the communication server (100) by video images, wherein the content information includes time information, where the time information fails to include any time zone related information; and comes with a format providing hours and minutes information only; and after the communication server (100) has received the initiation by the first mobile device (110) to show the content information to the second user, the communication server (100) processes the video images to determine if any time information included in the content information is found, where if the video images are found to include the time information, the communication server (100) performs time adjustment, including receiving the first geographic area of the first mobile device (110) after prompting the first mobile device (110)'s GPS receiver for location information receiving the second geographic area of the second mobile device (120) after prompting the second mobile device (120)'s GPS receiver for location information; based on the received first and second geographic areas, determining the first time zone and the second time zone respectively; computing time zone difference between the first and second geographic areas; and converting the time information in view of the computed time zone difference; the communication server (100) modifies the received video images by retaining the time information as unconverted time information; adding, as annotation, the time information with the converted time information in view of the time zone difference between the first and second geographic areas; the communication server (100) sends the modified video images to the second mobile device (120) for display; and the second mobile device (120) displays the modified video images to the second mobile user, including the unconverted time information and the converted time information in view of the time zone difference; and if the video images fail to include the time format, the communication server (100) sends the video images to the second mobile device (120) unmodified.

In yet an alternate embodiment, a system is provided. The system comprises a communication server (100) connecting the first mobile device (110) and the second mobile device (120); wherein the communication server (100) supports video conferences between two users; and the communication server (100) receives video images from one mobile device user and sends the video images to another mobile device user; a first mobile device (110) representing a remote device, wherein location capabilities of the first mobile device (110) include GPS technology only; the first mobile device (110) includes a first GPS receiver; the first mobile device (110) is being based in a geographic area of a time zone; and during the video conferences, documents are allowed to be sent by a first user of the first mobile device (110) to other users as video images; and a second mobile device (120) representing a local device, wherein location capabilities of the second mobile device (120) include GPS technology only; the second mobile device (120) is being based in the geographic area of the time zone; the second mobile device (120) includes a second GPS receiver; and a second user of the second mobile device (120) conducts a video conference with the first user of the first mobile device (110) through the communication server (100), where during the video conference, the first user of the first mobile device (110) has initiated to show certain content information of a document to the second user of the second mobile device (120) through the communication server (100) by video images, wherein the content information includes time information, where the time information fails to include any time zone related information; and comes with a format providing hours and minutes information only; and after the communication server (100) has received the initiation by the first mobile device (110) to show the content information to the second user, the communication server (100) processes the video images to determine if any time information included in the content information is found, where if the video images are found to include the time information, the communication server (100) performs time adjustment, including receiving the geographic area of the first mobile device (110) after prompting the first mobile device (110)'s GPS receiver for location information; receiving the geographic area of the second mobile device (120) after prompting the second mobile device (120)'s GPS receiver for location information; based on the received geographic areas from the first and second mobile device (120)s, determining the time zone of the first and second mobile devices; that the time zone of the first and second mobile devices are identical; the communication server (100) modifies the received video images by retaining the time information as unconverted time information; adding, as annotation, the geographic information to the video images; adding, as annotation, the time zone to the video images; the communication server (100) sends the modified video images to the second mobile device (120) for display; and the second mobile device (120) displays the modified video images to the second mobile user, including the unconverted time information, time zone information, and the geographic information; and if the video images fail to include the time format, the communication server (100) sends the video images to the second mobile device (120) unmodified.

Further to the embodiment, the communication server (100) may receive video images from one mobile device user and sends the video images to another mobile device user; a first mobile device (110) representing a remote device, wherein location capabilities of the first mobile device (110) include GPS technology only; the first mobile device (110) includes a first GPS receiver, the GPS receiver is being blocked from receiving signals; the first mobile device (110) is being based in a first geographic area of a first time zone; and during the video conferences, documents are allowed to be sent by a first user of the first mobile device (110) to other users as video images; and a second mobile device (120) representing a local device, wherein location capabilities of the second mobile device (120) include GPS technology only; the second mobile device (120) is being based in a second geographic area of a second time zone; the second mobile device (120) includes a second GPS receiver, the GPS receiver is being blocked from receiving signals; and a second user of the second mobile device (120) conducts a video conference with the first user of the first mobile device (110) through the communication server (100), where during the video conference, the first user of the first mobile device (110) has initiated to show certain content information of a document to the second user of the second mobile device (120) through the communication server (100) by video images, wherein the content information includes time information, the time information fails to include any time zone related information; and comes with a format providing hours and minutes information only; and after the communication server (100) has received the initiation by the first mobile device (110) to show the content information to the second user, the communication server (100) processes the video images to determine if any time information included in the content information is found, where if the video images are found to include the time information, the communication server (100) performs time adjustment, including requesting current times of the first mobile device (110) and second mobile device (120), after notified by the first and second mobile device (120)s that both of the first and second mobile device (120)s′ GPS receivers are being blocked; receiving the current times of the first and second mobiles; based on the current times, determining the first and second time zones respectively; computing time zone difference between the first and second geographic areas; and converting the time information in view of the computed time zone difference; the communication server (100) modifies the received video images by retaining the time information as unconverted time information; adding, as annotation, the time information with the converted time information in view of the time zone difference between the first and second geographic areas; the communication server (100) sends the modified video images to the second mobile device (120) for display; and the second mobile device (120) displays the modified video images to the second mobile user, including the unconverted time information and the converted time information in view of the time zone difference; and if the video images fail to include the time format, the communication server (100) sends the video images to the second mobile device (120) unmodified.

In another aspect of the invention, the embodied system may include the first mobile device (110) comprising a camera; the first mobile device (110) includes a first GPS receiver; and the first mobile device (110) is being based in a first geographic area of a first time zone; and during the video conferences, background information currently captured by the camera is allowed to be sent by a first user of the first mobile device (110) to other users as live video images; and a second mobile device (120) representing a local device, wherein location capabilities of the second mobile device (120) include GPS technology only; the second mobile device (120) is being based in a second geographic area of a second time zone; the second mobile device (120) includes a second GPS receiver; and a second user of the second mobile device (120) conducts a video conference with the first user of the first mobile device (110) through the communication server (100), where during the video conference, the first user of the first mobile device (110) has initiated to show certain content information to the second user of the second mobile device (120) through the communication server (100) by video images, wherein the content information includes background information currently captured by the camera, where the background information includes time information, where the time information fails to include any time zone related information; and comes with a format providing hours and minutes information only; and after the communication server (100) has received the initiation by the first mobile device (110) to show the content information to the second user, the communication server (100) processes the video images to determine if any time information included in the content information is found, where if the video images are found to include the time information, the communication server (100) performs time adjustment, including receiving the first geographic area of the first mobile device (110) after prompting the first mobile device (110)'s GPS receiver for location information; receiving the second geographic area of the second mobile device (120) after prompting the second mobile device (120)'s GPS receiver for location information; based on the received first and second geographic areas, determining the first time zone and the second time zone respectively; computing time zone difference between the first and second geographic areas; and converting the time information in view of the computed time zone difference; the communication server (100) modifies the received video images by retaining the time information as unconverted time information; adding, as annotation, the time information with the converted time information in view of the time zone difference between the first and second geographic areas; the communication server (100) sends the modified video images to the second mobile device (120) for display; and the second mobile device (120) displays the modified video images to the second mobile user, including the unconverted time information and the converted time information in view of the time zone difference; and if the video images fail to include the time format, the communication server (100) sends the video images to the second mobile device (120) unmodified.

While the invention has been shown and described with reference to particular embodiments thereof, it will be understood by those skilled in the art that the invention can be practiced, with modification, in other environments. For example, although the invention described above can be conveniently implemented in a general purpose computer selectively reconfigured or activated by software, those skilled in the art would recognize that the invention could be carried out in hardware, in firmware or in any combination of software, firmware or hardware including a special purpose apparatus specifically designed to perform the described invention. Therefore, changes in form and detail may be made therein without departing from the spirit and scope of the invention as set forth in the accompanying claims.

What is claimed is:

1. A video conference system for determining time information identified in documents presented as video images during video conferences, comprising:
a communication server connecting a first mobile device and a second mobile device.

2. The system of claim 1, wherein:
the communication server supports video conferences between two users; and
the communication server receives video images from one mobile device user and sends the video images to another mobile device user;
the system further comprises:
a first mobile device representing a remote device, wherein:
location capabilities of the first mobile device include GPS technology only;
the first mobile device includes a first GPS receiver;
the first mobile device is being based in a first geographic area of a first time zone; and
during the video conferences, documents are allowed to be sent by a first user of the first mobile device to other users as video images; and
a second mobile device representing a local device, wherein:
location capabilities of the second mobile device include GPS technology only;
the second mobile device is being based in a second geographic area of a second time zone;
the second mobile device includes a second GPS receiver; and
a second user of the second mobile device conducts a video conference with the first user of the first mobile device through the communication server, where:
during the video conference, the first user of the first mobile device has initiated to show certain content information of a document to the second user of the second mobile device through the communication server by video images,
wherein:
the content information includes time information,
where the time information:
fails to include any time zone related information; and
comes with a format providing hours and minutes information only; and
after the communication server has received the initiation by the first mobile device to show the content information to the second user,
the communication server processes the video images to determine if any time information included in the content information is found,
where:
if the video images are found to include the time information,
the communication server performs time adjustment, including:
receiving the first geographic area of the first mobile device after prompting the first mobile device's GPS receiver for location information;
receiving the second geographic area of the second mobile device after prompting the second mobile device's GPS receiver for location information;
based on the received first and second geographic areas, determining the first time zone and the second time zone respectively;
computing time zone difference between the first and second geographic areas; and
converting the time information in view of the computed time zone difference;
the communication server modifies the received video images by replacing the time information with the converted time information in view of the time zone difference between the first and second geographic areas;
the communication server sends the modified video images to the second mobile device for display; and
the second mobile device displays the modified video images to the second mobile user, including the converted time information in view of the time zone difference; and
if the video images fail to include the time format, the communication server sends the video images to the second mobile device unmodified.

3. The system of claim 1, wherein:
the communication server supports video conferences between two users; and
the communication server receives video images from one mobile device user and sends the video images to another mobile device user;
the system further comprises:
a first mobile device representing a remote device, wherein:
location capabilities of the first mobile device include GPS technology only;
the first mobile device includes a first GPS receive;
the first mobile device is being based in a first geographic area of a first time zone; and
during the video conferences, documents are allowed to be sent by a first user of the first mobile device to other users as video images; and
a second mobile device representing a local device, wherein:
location capabilities of the second mobile device include GPS technology only;
the second mobile device is being based in a second geographic area of a second time zone;
the second mobile device includes a second GPS receiver; and
a second user of the second mobile device conducts a video conference with the first user of the first mobile device through the communication server, where:
during the video conference, the first user of the first mobile device has initiated to show certain content information of a document to the second user of the second mobile device through the communication server by video images, wherein:
the content information includes time information,
where the time information:
fails to include any time zone related information; and
comes with a format providing hours and minutes information only; and
after the communication server has received the initiation by the first mobile device to show the content information to the second user,
the communication server processes the video images to determine if any time information included in the content information is found, where:
if the video images are found to include the time information,
the communication server performs time adjustment, including:
receiving the first geographic area of the first mobile device after prompting the first mobile device's GPS receiver for location information;
receiving the second geographic area of the second mobile device after prompting the second mobile device's GPS receiver for location information;
based on the received first and second geographic areas, determining the first time zone and the second time zone respectively;
computing time zone difference between the first and second geographic areas; and
converting the time information in view of the computed time zone difference;
the communication server modifies the received video images by:
retaining the time information as unconverted time information;
adding, as annotation, the time information with the converted time information in view of the time zone difference between the first and second geographic areas;
the communication server sends the modified video images to the second mobile device for display; and
the second mobile device displays the modified video images to the second mobile user, including the unconverted time information and the converted time information in view of the time zone difference; and
if the video images fail to include the time format, the communication server sends the video images to the second mobile device unmodified.

4. The system of claim 1, wherein:
the communication server supports video conferences between two users; and
the communication server receives video images from one mobile device user and sends the video images to another mobile device user;
the system further comprises:
a first mobile device representing a remote device, wherein:
location capabilities of the first mobile device include GPS technology only;
the first mobile device includes a first GPS receiver;
the first mobile device is being based in a geographic area of a time zone; and
during the video conferences, documents are allowed to be sent by a first user of the first mobile device to other users as video images; and
a second mobile device representing a local device, wherein:
location capabilities of the second mobile device include GPS technology only;
the second mobile device is being based in the geographic area of the time zone;
the second mobile device includes a second GPS receiver; and
a second user of the second mobile device conducts a video conference with the first user of the first mobile device through the communication server, where:
during the video conference, the first user of the first mobile device has initiated to show certain content information of a document to the second user of the second mobile device through the communication server by video images,
wherein:
the content information includes time information, where the time information:
fails to include any time zone related information; and
comes with a format providing hours and minutes information only; and
after the communication server has received the initiation by the first mobile device to show the content information to the second user,
the communication server processes the video images to determine if any time information included in the content information is found,
where:
if the video images are found to include the time information,
the communication server performs time adjustment, including:
receiving the geographic area of the first mobile device after prompting the first mobile device's GPS receiver for location information;
receiving the geographic area of the second mobile device after prompting the second mobile device's GPS receiver for location information;
based on the received geographic areas from the first and second mobile devices, determining:
the time zone of the first and second mobile devices;
that the time zone of the first and second mobile devices are identical;
the communication server modifies the received video images by:
retaining the time information as unconverted time information;
adding, as annotation, the geographic information to the video images;
adding, as annotation, the time zone to the video images;
the communication server sends the modified video images to the second mobile device for display; and
the second mobile device displays the modified video images to the second mobile user, including the unconverted time information, time zone information, and the geographic information; and
if the video images fail to include the time format, the communication server sends the video images to the second mobile device unmodified.

5. The system of claim 1, wherein:
the communication server supports video conferences between two users; and
the communication server receives video images from one mobile device user and sends the video images to another mobile device user;
the system further comprises:
a first mobile device representing a remote device, wherein:
location capabilities of the first mobile device include GPS technology only;
the first mobile device includes a first GPS receiver, the GPS receiver is being blocked from receiving signals;
the first mobile device is being based in a first geographic area of a first time zone; and
during the video conferences, documents are allowed to be sent by a first user of the first mobile device to other users as video images; and
a second mobile device representing a local device, wherein:
location capabilities of the second mobile device include GPS technology only;
the second mobile device is being based in a second geographic area of a second time zone;
the second mobile device includes a second GPS receiver, and
a second user of the second mobile device conducts a video conference with the first user of the first mobile device through the communication server, where:
during the video conference, the first user of the first mobile device has initiated to show certain content information of a document to the second user of the second mobile device through the communication server by video images,
wherein:
the content information includes time information,
where the time information:
fails to include any time zone related information; and
comes with a format providing hours and minutes information only; and
after the communication server has received the initiation by the first mobile device to show the content information to the second user,
the communication server processes the video images to determine if any time information included in the content information is found,
where:
if the video images are found to include the time information,
the communication server performs time adjustment, including:
requesting current time of the first mobile device, after notified by the first mobile device that the first mobile device's GPS receiver is being blocked;
receiving the current time;
based on the current time, determining the first time zone;
receiving the second geographic area of the second mobile device after prompting the second mobile device's GPS receiver for location information;
based on the second geographic area, determining the second time zone;
computing time zone difference between the first and second geographic areas; and
converting the time information in view of the computed time zone difference;
the communication server modifies the received video images by:
retaining the time information as unconverted time information;
adding, as annotation, the time information with the converted time information in view of the time zone difference between the first and second geographic areas;
the communication server sends the modified video images to the second mobile device for display; and
the second mobile device displays the modified video images to the second mobile user, including the unconverted time information and the converted time information in view of the time zone difference; and
if the video images fail to include the time format, the communication server sends the video images to the second mobile device unmodified.

6. The system of claim 1, wherein:
the communication server supports video conferences between two users; and
the communication server receives video images from one mobile device user and sends the video images to another mobile device user;
the system further comprises:
a first mobile device representing a remote device, wherein:
location capabilities of the first mobile device include GPS technology only;
the first mobile device includes a camera;
the first mobile device includes a first GPS receiver; and
the first mobile device is being based in a first geographic area of a first time zone; and
during the video conferences, background information currently captured by the camera is allowed to be sent by a first user of the first mobile device to other users as live video images; and
a second mobile device representing a local device, wherein:
location capabilities of the second mobile device include GPS technology only;
the second mobile device is being based in a second geographic area of a second time zone;
the second mobile device includes a second GPS receiver; and
a second user of the second mobile device conducts a video conference with the first user of the first mobile device through the communication server, where:
during the video conference, the first user of the first mobile device has initiated to show certain content information to the second user of the second mobile device through the communication server by video images, wherein:
the content information includes background information currently captured by the camera, where the background information includes time information,
where the time information:
fails to include any time zone related information; and
comes with a format providing hours and minutes information only; and
after the communication server has received the initiation by the first mobile device to show the content information to the second user,
the communication server processes the video images to determine if any time information included in the content information is found,
where:
if the video images are found to include the time information,
the communication server performs time adjustment, including:
receiving the first geographic area of the first mobile device after prompting the first mobile device's GPS receiver for location information;
receiving the second geographic area of the second mobile device after prompting the second mobile device's GPS receiver for location information;
based on the received first and second geographic areas, determining the first time zone and the second time zone respectively;
computing time zone difference between the first and second geographic areas; and
converting the time information in view of the computed time zone difference;
the communication server modifies the received video images by:
retaining the time information as unconverted time information;
adding, as annotation, the time information with the converted time information in view of the time zone difference between the first and second geographic areas;
the communication server sends the modified video images to the second mobile device for display; and
the second mobile device displays the modified video images to the second mobile user, including the unconverted time information and the converted time information in view of the time zone difference; and
if the video images fail to include the time format, the communication server sends the video images to the second mobile device unmodified.

7. The system of claim 1, wherein:
the communication server supports video conferences between two users; and
the communication server receives video images from one mobile device user and sends the video images to another mobile device user;
the system further comprises:
a first mobile device representing a remote device, wherein:
location capabilities of the first mobile device include GPS technology only;
the first mobile device includes a first GPS receiver;
the first mobile device is being based in a first geographic area of a first time zone; and
during the video conferences, documents are allowed to be sent by a first user of the first mobile device to other users as video images; and
a second mobile device representing a local device, wherein:
location capabilities of the second mobile device include GPS technology only;
the second mobile device is being based in a second geographic area of a second time zone;
the second mobile device includes a second GPS receiver; and
a second user of the second mobile device conducts a video conference with the first user of the first mobile device through the communication server, where:
during the video conference, the first user of the first mobile device has initiated to show certain content information of a document to the second user of the second mobile device through the communication server by video images,
wherein:
the content information includes time information, where the time information:
fails to include any time zone related information; and
comes with a format providing hours and minutes information only; and
after the communication server has received the initiation by the first mobile device to show the content information to the second user, the communication server, without modifying the video images, sends the content information to the second mobile device;
when received the content information from the communication server, the second mobile device performs time adjustment, including:
processing the video images to determine if any time information included in the content information is found, where:
if the video images are found to include the time information,
the second mobile device performs time adjustment, including:
receiving the first geographic area of the first mobile device after prompting the first mobile device's GPS receiver for location information;
retrieving the second geographic area of the second mobile device after prompting the second mobile device's GPS receiver for location information;
based on the received first and second geographic areas, determining the first time zone and the second time zone respectively;
computing time zone difference between the first and second geographic areas; and
converting the time information in view of the computed time zone difference;
the second mobile device modifies the received video images by:
retaining the time information as unconverted time information;
adding, as annotation, the time information with the converted time information in view of the time zone difference between the first and second geographic areas; and
the second mobile device displays the modified video images to the second mobile user, including the unconverted time information and the converted time information in view of the time zone difference; and
if the video images fail to include the time format, the second mobile device displays the video images to the second user unmodified.
